(19) United States
(12) Patent Application Publication
(10) Pub. No.: US 2015/0114517 A1
(43) Pub. Date: Apr. 30, 2015

(54) LIFTING DEVICE FOR CONTAINER HANDLING MACHINES AND A CONTAINER HANDLING MACHINE

(71) Applicant: KHS GmbH, Dortmund (DE)

(72) Inventors: Ludwig Clüsserath, Bad Kreuznach (DE); Dieter-Rudolph Krulitsch, Bad Kreuznach (DE)

(73) Assignee: KHS GmbH a corporation

(21) Appl. No.: 14/396,435

(22) PCT Filed: Apr. 27, 2013
(86) PCT No.: PCT/EP2013/001270

§ 371 Date: Oct. 23, 2014

(30) Foreign Application Priority Data
May 4, 2012 (DE) 10 2012 008 755.1

(51) Int. Cl. B67C 3/24; B67C 3/28; B67C 3/22

(52) U.S. Cl. CPC B67C 3/244; B67C 3/225; B67C 3/282
USPC 141/83; 141/172

(57) ABSTRACT

A container-lifting device includes a cam, and lifting elements. Each lifting elements has a container carrier on a slide element, a deformable fluid-pressure actuation element, and a guideway, separate from the actuation element, for guiding the slide element. The lifting element moves between first and second lifting positions. The control cam interacts with the slide elements to move them into the second lifting position. The actuation element, when pressurized, pretensions the slide element into the first lifting position. The actuation element has a wall that delimits an interior chamber to which the fluid pressure is applied. The actuation element is a ball-type element, a membrane-type element, or a bellows-type element.

### RELATED APPLICATIONS

This application is the national stage under 35 USC 371 of PCT application PCT/EP2013/001270, filed Apr. 27, 2013, which claims the benefit of the May 4, 2012 priority date of DE 10 2012 008 755.1.

### FIELD OF INVENTION

The invention relates to a lifting device and to a container-handling machine.

### BACKGROUND

Lifting devices for container-handling machines, including filling machines, are known. These lifting devices typically comprise a plurality of lifting elements that are provided on the perimeter of a rotor of the handling machine. The rotor can be driven to rotate about a vertical machine axis.

In known devices, each lifting element has a container carrier for a container that, for the purpose of filling, is first lifted up out of a lower lifting position against a filling element disposed above the container carrier and is then lowered back into a lower lifting position after filling. Each lifting element has a slide element that is carried on a guideway in the axial direction of the lifting movement and on which the container carrier is also provided, and a fluid-pressure actuation element that, during the operation of the filling machine, is charged with a fluid pressure and that pretensions the slide element with the container carrier in the upper lifting position, i.e. acts as an “air spring.” On the slide element of each lifting element there is also provided a cam roller that interacts with a control cam provided on a machine frame of the filling machine to effect movement of the slide elements with the container carriers into the lower lifting position against the action of the fluid pressure actuation elements. In the case of the known container-handling machines or filling machines, the latter are formed essentially by piston/cylinder arrangements, with these piston/cylinder arrangements or their piston rods and/or pistons also being part of the respective guideway at the same time.

The known lifting devices are generally configured for a long stroke of at least 300 mm. Such devices are complicated to construct and expensive. They also have the added disadvantage of requiring constant lubrication for all of the friction bearing points of the guideways. It is also often necessary to add a lubricant, such as oil, to the pressure medium for the fluid pressure actuation elements formed by piston/cylinder arrangements.

This lubricant is also needed to sufficiently lubricate the sealing elements present in the above mentioned piston/cylinder arrangements for sealing the piston against the cylinder wall.

These sealing elements in particular represent a significant disadvantage of the state of the art. These sealing elements, for example O-rings or packings used as piston rings, are permanently subjected to a translation with alternating directions of motion, changes in speed and acceleration, and standstills. As a result, the sealing elements are exposed to a high degree of wear and tear. This, in turn, results in substantial maintenance costs.

### SUMMARY

The invention features a lifting device that facilitates a simplified constructional configuration of the lifting elements while avoiding the aforesaid disadvantages and while providing high operational reliability.

One particularity of the inventive lifting device is that, in the individual lifting elements, the guideway and the respective fluid pressure actuation element are separate in both construction and function, i.e. in particular the respective fluid pressure actuation element has no guideway function.

Other particularities of the inventive lifting device are that the guideway has no sealing elements and/or that the fluid pressure actuation elements have no guiding function.

In a preferred embodiment of the invention the respective fluid pressure actuation element is a ball-type, membrane-type or bellows-type element having a deformable wall that tightly delimits at least one interior chamber to which the fluid pressure may be applied. The elements that form the guideway, i.e. at least one guide rod forming the guideway or its axis and the fluid pressure actuation element or its working axis, are spatially offset from one another. The guideway preferably has two guide rods, with the fluid pressure actuation element then being disposed, for example, between these guide rods.

Because the guideway and fluid pressure actuation element are separate in construction, it is possible to dispense with sealing elements for sealing during translation of, in particular, the guideway. This eliminates the problem of wear on the sealing elements.

The lifting elements are preferably configured for a relatively short stroke whose length accounts, for example for just a fraction, e.g. at most 15-20%, of the guide length with which the respective slide element is guided on a guide rod of the guideway. A significant reduction in wear is also achieved by the relatively short stroke, which is, for example, a maximum of 50 millimeters, and preferably a maximum of only 30 millimeters to 40 millimeters.

In order to facilitate the short stroke, when the container-handling machine is configured as a filling machine with filling elements that during filling have filling tubes extending into the containers or probes that determine the filling level, these filling tubes or probes are height adjustable so that when the container carrier is lowered for the positioning of the respective empty container under the filling element or for the removing of the filled container, they can be moved to their upper position.

Because the fluid pressure actuation elements have no guide function and so, for this reason alone, there is no need to add lubricant or oil to the pressure medium that is fed to them, this pressure medium can also be used to actuate valves of handling heads, for example of filling elements of the container-handling machine, without the risk of having the lubricant enter the containers or filling material in the event of a fault. Using one and the same pressure medium for both the fluid pressure actuation elements and the control valves has the advantage of requiring only a single rotary connection for feeding the pressure medium from an external pressure source to the pressure channels that are configured on the rotor of the container-handling machine. This further simplifies the container-handling machine.

For the purpose of the invention the expressions “essentially,” “in essence,” or “around” mean variations from the respective exact value by +/−10%, preferably by +/−5%, and/or variations in the form of changes that are insignificant for the function.

As used herein, “probes determining the filling level” are probes that extend into the container during filling and with which the desired filling level is controlled and/or adjusted.

As used herein, “fluid pressure actuation elements” are machine elements or actuators that generate a force and/or movement in at least one working axis when charged with a fluid pressure, e.g. gas pressure or air pressure. These fluid pressure actuation elements are preferably ball-type, membrane-type or bellow-types actuation elements.

In one aspect, the invention features an apparatus for use in lifting containers. Such an apparatus includes a lifting device having a control cam, and lifting elements. Each of the lifting elements includes a container carrier, a slide element, a fluid-pressure actuation element, and a guideway. The container carrier is on the slide element. The guideway is configured for guiding the slide element. The lifting element is movable between a first lifting position and a second lifting position. The fluid-pressure actuation element is separate from the guideway in construction and function. The control cam is configured to interact with the slide elements of the lifting elements to move the slide elements into the second lifting position. The fluid pressure actuation element is configured such that, when pressurized with fluid pressure, the fluid pressure actuation element pretensions the slide element into the first lifting position. The fluid pressure actuation element includes a wall that delimits an interior chamber to which the fluid pressure may be applied. The fluid pressure actuation element includes an element selected from the group consisting of a ball-type element, a membrane-type element, and a bellows-type element, and wherein the fluid pressure actuation element is deformable.

In some embodiments, the first lifting position is an upper lifting position, and the second lifting position is a lower lifting position.

In other embodiments, a first structure, which can be a guideway, a guide element that forms a guideway, or an axis of a guide element, and a second structure is either of a fluid pressure actuation element or a working axis of a fluid pressure actuation element. The first structure is spatially offset from the second structure along a direction that is radial to an axis along which the container carrier is moved during a transition between the first lifting position and the second lifting position.

In yet other embodiments, at each lifting element, the guideway includes a first guide element, and a second guide element, the first guide element being arranged parallel to and spaced apart from the second guide element, and with the first guide element and the second guide element cooperating in forming the guideway. In these embodiments, the fluid pressure actuation element of the lifting element is arranged between the first guide element and the second guide element.

Also included are embodiments in which, at each lifting rod, the guideway includes a first guide rod, and a second guide rod. In these embodiments, the first guide rod is arranged parallel to and spaced apart from the second guide rod, wherein the first guide rod and the second guide rod cooperate in forming the guideway, and the fluid pressure actuation rod of the lifting rod is arranged between the first guide rod and the second guide rod.

Other embodiments have a common pressure channel, with the fluid pressure actuation elements of all of the lifting elements being connected to the common pressure channel.

Yet other embodiments have a cam roller, with the slide elements of the lifting elements each interacting with the control cam through the cam roller.

Also among the embodiments are those that have a transport element that includes a section, and an arm that projects laterally from the slide element, wherein the fluid pressure actuation element acts between the section and the arm. In some embodiments, the section is an annular section.

Embodiments also include those in which each lifting element is configured for a maximum stroke of 50 millimeters, and preferable with a maximum stroke of between 30 millimeters and 40 millimeters.

In some embodiments, the guideway is free of sealing elements.

In other embodiments, the fluid pressure actuation element does not have a guiding function.

In yet another aspect, the invention features includes a container handling machine that has a transport element having the lifting device provided thereon. The container handling machine can be, for example, a filling machine. In some of these embodiments, the filling machine has a rotor that rotates about a machine axis of the filling machine with the lifting device being provided on the rotor.

Yet other embodiments have a pressure source for a common pressure medium, a container handling machine including a transport element, and a common rotary connection between the pressure source and the transport element, wherein the lifting device is provided on the transport element, wherein the lifting elements each comprise a handle, wherein the handle, together with the lifting element, defines a handling position, wherein the apparatus further includes a pressure-medium-actuated control valve for each handle, wherein the common pressure medium from the pressure source pressurizes actuation elements of all of the lifting elements, and wherein the common pressure medium from the pressure source activates the control valves of the handles, wherein the common pressure medium is fed via the common rotary connection from the pressure source, and wherein the handle is selected from the group consisting of a handling element and a handling head.

Also among the embodiments are those that have a filling machine including a transport element, a pressure source for a common pressure medium, and a common rotary connection between the pressure source and the transport element, wherein the lifting device is provided on the transport element, wherein the lifting elements each comprise a handle, wherein the handle, together with the lifting element, defines a filling position, wherein the apparatus further includes a pressure-medium-actuated control valve for each handle, wherein the common pressure medium from the pressure source pressurizes actuation elements of all of the lifting elements, and wherein the common pressure medium from the pressure source activates the control valves of the handles, wherein the common pressure medium is fed via the common rotary connection from the pressure source, and wherein the handle is selected from the group consisting of a handling element and a handling head.

Other embodiments include a filling machine, wherein the lifting elements are disposed on a transport element of the filling machine, wherein the lifting elements each comprise a handle, wherein the handle, together with the lifting element, defines a filling position, wherein each lifting element further includes a structure that is configured to selectively extend into a container, wherein the structure is height adjustable in a direction extending between the first lifting position and the second lifting position, wherein the structure is selected from the group consisting of a filling tube that extends into a container during filling thereof and a probe that determines a filling level in the container.

Embodiments also include those in which the fluid pressure actuation element is manufactured from an elastic material, and those in which it is manufactured from a plastic material.

In another aspect, the invention features a container-lifting device that includes a cam, and lifting elements. Each lifting elements has a container carrier on a slide element, a deformable fluid-pressure actuation element, and a guideway, separate from the actuation element, for guiding the slide element. The lifting element moves between first and second lifting positions. The control cam interacts with the slide elements to move them into the second lifting position. The actuation element, when pressurized, pretensions the slide element into the first lifting position. The actuation element has a wall that delimits an interior chamber to which the fluid pressure is applied. The actuation element is a ball-type element, a membrane-type element, or a bellows-type element.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

### DESCRIPTION OF THE DRAWINGS

The invention is explained in detail below through the use of an embodiment example with reference to the figures. In the figures:

FIG. 1 shows a schematic representation and plan view of a rotary-type filling machine for filling containers with a liquid filling material; and

FIG. 2 shows an enlarged representation of one of the filling positions of the filling machine in FIG. 1.

### DETAILED DESCRIPTION

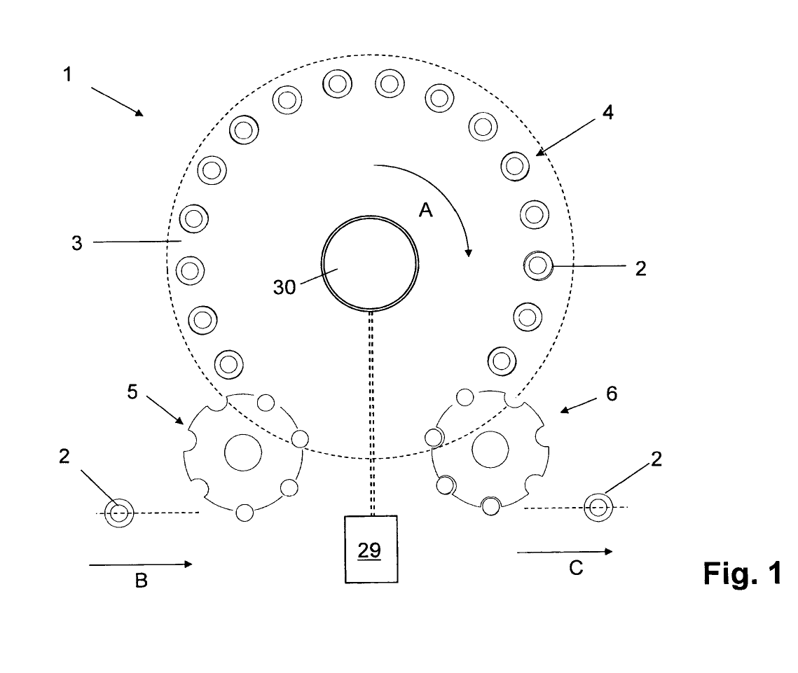

FIG. 1 shows a rotary-type filling machine 1 that is used to fill containers 2 in the form of bottles with a liquid filling material. The filling machine 1 comprises a rotor 3 that is mounted on a machine frame 1.1 and that can be driven to rotate about a vertical machine axis MA (arrow A). The rotor 3 has a periphery on which are formed a plurality of filling positions 4 distributed at equal angular distances around the machine axis MA and at the same radial distance from the machine axis MA.

Empty containers 2 that are to be filled are fed by an external transporter (arrow B) and are each transferred to a filling position 4 at a container inlet 5. At a container outlet 6, filled containers 2 are removed from the filling positions 4 and passed on for further handling (arrow C). The filling of containers 2 is carried out within an angular range of the rotary trajectory of the rotor 3 that extends between the container inlet 5 and a container outlet 6.

In the depicted embodiment, each filling position 4 comprises a filling element 7 and a container carrier 8 that is associated with and positioned beneath filling element 7.

In the depicted embodiment, the container carrier 8 is configured as a container plate or bottle plate on which, during the filling process, a container 2 stands upright on its base with its container axis oriented parallel to the machine axis MA.

Each container carrier 8 is provided at an upper end of a rod 9 oriented with its axis parallel to the machine axis MA and mounted height-adjustably on a support arm 10 of a lifting element 11 with which the container carrier 8, and hence also container 2 standing thereon, can, in a manner described more fully below, be controlled to move up and down through a stroke D on a filling element axis FA that is oriented parallel to the machine axis MA as a function of the respective angular position of the filling position 4 as the rotor 3 rotates.

With each filling position 4, there is associated its own lifting element 11 that comprises a sleeve-like slide element 12 having a lower end to which a support arm 10 is attached by an end thereof and an upper end to which an arm 13 is attached. The slide element 12 lies radially inward relative to the machine axis MA. From the upper end, the arm 13 projects radially inward relative to machine axis MA.

For the lifting movement and/or stroke D, the slide element 12 is arranged to slide on a first guide rod 14 that is attached by its upper end to the rotor 3 or to a rotor part 3.1 with its axis parallel to the machine axis MA. The lower end of the first guide rod 14 is attached to a ring 15 that concentrically surrounds the machine axis MA and by which the lower ends of the first guide rods 14 of the lifting elements 11 of all other filling positions 4 are also attached. As a result, the first guide rods 14 of all the lifting elements 11 of the filling machine 1 support one another by their common ring 15.

In order to for the slide element 12 to slide on its first guide rod 14 without the risk of twisting, and hence to achieve a high operational reliability for the lifting elements 11, the slide element 12 has an axial length, or guide length, that is preferably many times greater than the maximum stroke D of the lifting device 11 or of container carrier 8. In the depicted embodiment this maximum stroke is for example 40 units while the axial length of slide element 12 is around 260-270 units. The maximum stroke D is thus around 15% of the axial length of slide element 12. In a typical embodiment, a unit is equal to a millimeter.

A free end of the arm 13 that lies on the inside relative to machine axis MA is guided on a second guide rod 16 whose axis is also oriented parallel to the machine axis MA. In the depicted embodiment, the second guide rod 16 has its axis disposed in a common plane with the axis of the first guide rod 14 and the machine axis MA. The second guide rod 16, which acts as a locking device for the lifting element 11, is held at both of its ends on the rotor 3 or the rotor element 3.1. In the depicted embodiment, the rotor element 3.1 is configured with a cylindrical rotor section 17 concentrically surrounding the machine axis MA and with upper and lower annular rotor sections 18 and 19 arranged with their surface sides in planes normal to the machine axis MA and concentrically surrounding the machine axis MA. These annular rotor sections 18 and 19, which are spaced apart from one another along the machine axis MA, project over the peripheral side of the cylindrical rotor section 17 that lies radially outward relative to machine axis MA. The first guide rods 14 and the upper ends of the second guide rods 16 of all the lifting elements 11 are attached to the upper annular rotor section 18. The lower ends of the second guide rods 16 of all the lifting elements 11 are attached to the lower annular rotor section 19.

A fluid pressure actuation element 20 is disposed in a space between the first and second guide rods 14, 16 so that it acts between the arm 13 and the lower annular rotor section 19. A pressure channel 21, which is configured in the lower annular rotor section 19, connects the fluid pressure actuation elements 20 of all the lifting elements 11 of all the filling positions 4 to a pressure source.

When charged with a fluid pressure, the fluid pressure actuation element 20 generates a force that acts between the arm 13 and the lower annular rotor section 19. This force tends to raise the slide element 12, and hence the container carrier 8. The fluid pressure arises from, for example, a gaseous and/or vaporous medium, preferably compressed air or compressed gas.

In the depicted embodiment, a wall 20.1 of the fluid pressure actuation element 20 seals an interior chamber thereof. The interior chamber of the actuation element 20 connects to a pressure channel 21. In some embodiments, the wall 20.1 is deformable. Among these are embodiments in which the wall is a bellows, as well as embodiments in which it is made of an elastic material, for example rubber or a ductile plastic. Other embodiments of the fluid pressure actuation element 20 include a piston/cylinder arrangement disposed between the arm 13 and the lower annular rotor section 19 or a ball-type or membrane-type fluid pressure actuation element. When charged with fluid pressure, the fluid pressure actuation element 20 raises slide element 12, and hence the container carrier 8.

Common to all of the foregoing embodiments, however, is that the fluid pressure actuation element 20 does not guide the lifting movement of the container carrier 8. Instead, a separate guide performs this guide function. In the depicted embodiment it is the first and second guide rods 14 and 16 and the associated guideways of the slide element 12 that carry out this guide function. They do so in a lubricant-free manner.

Because it does not guide, the fluid pressure actuation element 20 is freed of any loads, forces and/or constraints imposed by having to guide, especially when the fluid pressure actuation element 20 is configured as a bellows or as a ball-type or membrane-type fluid pressure actuation element. By its design alone, fluid pressure actuation element 20 has no or essentially no guide function. By separating the stroke functions from the guide functions in both design, construction, and function, it is also possible to use a lubricant-free medium as the pressure medium. This makes it possible to eliminate sealing elements for translation movements.

During the operation of filling machine 1, the fluid pressure actuation elements 20 of all of the lifting elements 11 are constantly charged with the fluid pressure (e.g. compressed air or compressed gas) via the common pressure channel 21. As a result, the fluid pressure actuation elements 20 all act as air or gas spring elements that pretension their respective slide elements 12, and the container carriers 8 provided thereon, into the upper lifting position.

By way of a cam roller 22, which can freely rotate about an axis radial to machine axis MA at the lower end of the slide element 12, and which is located beneath or essentially beneath the fluid pressure actuation element 20, and which interacts with a control cam 23 that does not rotate with rotor 3 and that concentrically surrounds the machine axis MA, the slide element 12 and the container carrier 8 on the orbit of rotor 3 are moved down against the action of the force generated by the fluid pressure actuation element 20 and into the lower lifting position whenever a lowering of the container carrier 8 becomes necessary, for example when the container carrier 8 is within the angular range of the rotary motion of the rotor 3 between the container outlet 6 and the container inlet 5.

Preferably, the lifting element 11 and the pressurizing of the corresponding fluid pressure actuation element 20 should not be controlled or regulated centrally for all lifting elements 11 together. Instead, the fluid pressure actuation element 20 is controlled or regulated locally for each lifting element 11 individually. If, for example, the use of individually operable fluid valves provided for each lifting element 11 individually makes it possible to raise or lower each individual lifting element 11 independently of the other lifting elements 11, then the complex and expensive control cam 23 can be dispensed with. This elimination of control cam 23 brings significant cost benefits.

Such an embodiment results in further advantages because operation of a lifting element 11 and of the extending or retracting movements of the corresponding filling tube or of the corresponding probe that determines the filling level can be initiated by the same pneumatic or hydraulic valves. This achieves further cost savings.

A further particularity of the lifting element 11 or of the lifting device that it forms is that the lifting elements 11 is configured for a short stroke D, i.e. for a stroke D of no more than 50 millimeters. Among other things this creates the further advantage that the bearing points, and in particular, the guideway for lifting movement D, require no lubrication.

The filling elements 7 are configured in the known manner. On the underside of each filling element 7 in the region of a centering tulip 24, there is at least one delivery opening for the liquid filling material that, during filling, flows to a container 2 and does so under the control of a fluid valve provided in the filling element 7. The liquid filling material flows from a filling material tank 25 that is provided for all the filling elements 7 together on the rotor 3 or the rotor part 3.2.

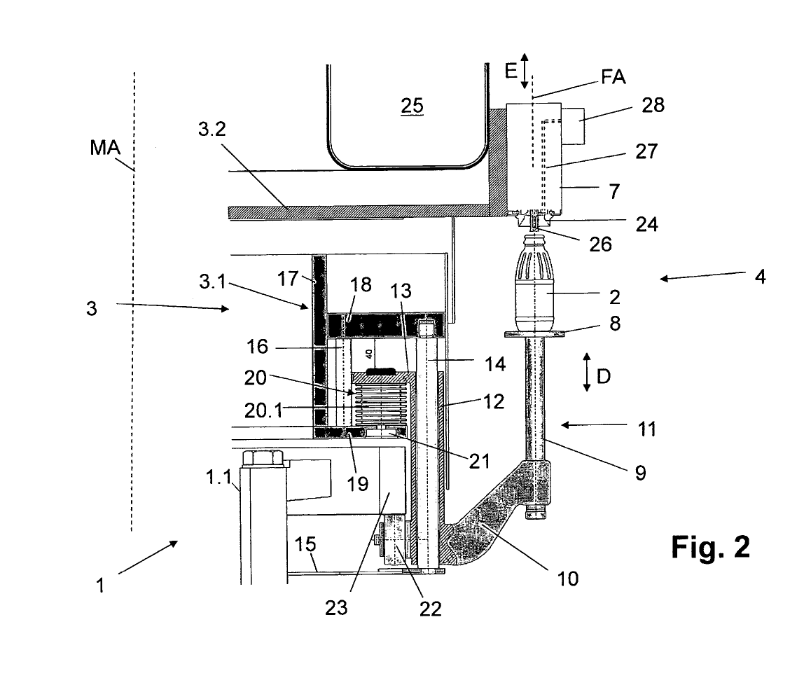

In the embodiment shown in FIG. 2, each filling element 7 has an insertable structure 26 that is either a filling tube or a probe 26 that determine filling levels. The insertable structure 26 is preferably height adjustable, and in particular, can move up and down on filling element axis FA as shown by the double arrow E in FIG. 2. This facilitates the short stroke D for container carriers 8 despite the presence of the insertable structure 26. In embodiments in which the insertable structure 26 is a probe that determines the filling level, the probe is, for example, one with electrical probe contacts or return gas tubes.

The illustrated filling machine 1 is suitable, for example, for the pressure-filling of containers 2. To do so, the filling machine 1 transfers the container 2 to a filling position 4 at the container inlet 5, and raises the 2 along the filling element axis FA using the initially lowered container carrier 8. After being raised, the container 2 sits with its container mouth, which is being pressed by the pressing force generated by fluid pressure actuation element 20, in sealed contact against the filling element 7 or against a seal that is disposed inside the centering tulip 24 and that surrounds the delivery opening located thereat.

The actual filling process then follows, preferably in multiple phases in which the container 2 is, for example, first evacuated, purged, and preloaded with an inert gas, such as carbon dioxide gas, whereupon the liquid filling material is delivered into container 2 in a subsequent filling phase. The now filled container 2 is then let down to ambient pressure at the end of a multi-stage depressurizing phase.

In order to facilitate the different handling phases, different gas paths 27 are configured in the filling element 7, of which only one is shown very schematically. Control valves 28, which are actuated by a pressure medium, control flow through these gas paths 27. This pressure medium is supplied through a rotary connection 30 and pressure pipes, which are not shown, that are provided on the rotor 3 from an external pressure source 29 that does not rotate with rotor 3. Because, as described above, a lubricant-free or oil-free pressure medium can be used to pressurize the fluid pressure actuation elements 20, the rotary connection 30 is provided both for supplying the fluid pressure actuation elements 20 with the pressure medium and for supplying the pressure medium to actuate the control valves 28.

The invention has been described hereinbefore by reference to one embodiment. It goes without saying that numerous variations as well as modifications are possible without departing from the inventive concept underlying the invention.

It has been assumed above for example that during the operation of the filling machine 1, all fluid pressure actuation elements 20 are constantly charged with the pressure of the pressure medium (e.g. compressed air or compressed gas) and that the lowering of the container carriers 8 is effected by the cam rollers 22 and the control cam 23 against the action of respective fluid pressure actuation elements 20.

It is however also possible, in principle, for the fluid pressure actuation elements 20 or their pressurization, to be controlled individually for the filling positions 4 as a function of the respective rotational position of the rotor 3, i.e. for example to depressurize a fluid pressure actuation element 20 within a particular angular region of the rotary motion of the rotor 3, or to reduce the pretension force generated by the fluid pressure actuation element 20 within a particular angular region of the rotary motion of rotor 3 in which the lowering of the container carrier 8 is necessary.

One way to depressurize a fluid pressure actuation element 20 is to vent it to the atmosphere. Another way to depressurize a fluid pressure actuation element 20 is to charge it with a vacuum. In either case, depressurization causes the respective cam roller 22 to be either lifted off or separated from the control cam 23 or to, at most, sit against the control cam 23 with a reduced force. This reduces wear of the lifting elements 11 and the control cam 23.

Irrespective of this, however, it is generally possible to simultaneously depressurize all fluid pressure actuation elements 20 or to charge them with a vacuum so that, for example, when the filling machine 1 is being serviced or repaired, it is easier to rotate the rotor 3 while the container carriers 8 remain lowered in the lower lifting position and cam rollers 22 are raised by control cam 23. This provides optimum accessibility to the filling positions 4 or to their filling elements 7.

It was also assumed above that the container carriers 8 are configured as carrier plates on which containers 2 stand upright on their bases. The container carriers 8 of the filling machine 1 can, however, be configured differently. For example, the container carriers 8 can be configured for suspending containers 2 from a mouth flange. In the case in which the containers 2 are bottles, a mouth flange is usually provided beneath the bottle mouth.

It was also assumed above that a single rotary connection 30 is provided for feeding the pressure medium. However, in alternate embodiments, there are separate rotary connections to provide the pressure medium for the fluid pressure actuation elements 20 and the pressure medium for operating the control valves 28.

Having described the invention, and a preferred embodiment thereof, what is claimed as new and secured by Letters Patent is:

1-12. (canceled)

13. An apparatus for use in lifting containers, said apparatus comprising a lifting device, said lifting device comprising a control cam, and lifting elements, wherein each of said lifting elements comprises a container carrier, a slide element, a fluid-pressure actuation element, and a guideway, wherein said container carrier is on said slide element, wherein said guideway is configured for guiding said slide element, wherein said lifting element is movable between a first lifting position and a second lifting position, wherein, said fluid-pressure actuation element is separate from said guideway in construction and function, wherein said control cam is configured to interact with said slide elements of said lifting elements to move said slide elements into said second lifting position, wherein said fluid pressure actuation element is configured such that, when pressurized with fluid pressure, said fluid pressure actuation element pretensions said slide element into said first lifting position, wherein said fluid pressure actuation element comprises a wall that delimits an interior chamber to which said fluid pressure may be applied, wherein said fluid pressure actuation element comprises an element selected from the group consisting of a ball-type element, a membrane-type element, and a bellows-type element, and wherein said fluid pressure actuation element is deformable.

14. The apparatus of claim 13, wherein said first lifting position is an upper lifting position, and wherein said second lifting position is a lower lifting position.

15. The apparatus of claim 13, wherein a first structure is selected from the group consisting of a guideway, a guide element that forms a guideway, and an axis of a guide element, and a second structure is selected from the group consisting of a fluid pressure actuation element and a working axis of a fluid pressure actuation element, wherein said first structure is spatially offset from said second structure along a particular direction, and wherein said particular direction is a direction that is radial to an axis along which said container carrier is moved during a transition between said first lifting position and said second lifting position.

16. The apparatus of claim 13, wherein, at each lifting element, said guideway comprises a first guide element, and a second guide element, wherein said first guide element is arranged parallel to and spaced apart from said second guide element, wherein said first guide element and said second guide element cooperate in forming said guideway, and wherein said fluid pressure actuation element of said lifting element is arranged between said first guide element and said second guide element.

17. The apparatus of claim 13, wherein, at each lifting rod, said guideway comprises a first guide rod, and a second guide rod, wherein said first guide rod is arranged parallel to and spaced apart from said second guide rod, wherein said first guide rod and said second guide rod cooperate in forming said guideway, and wherein said fluid pressure actuation rod of said lifting rod is arranged between said first guide rod and said second guide rod.

18. The apparatus of claim 13, further comprising a common pressure channel, wherein fluid pressure actuation elements of all of said lifting elements are connected to said common pressure channel.

19. The apparatus of claim 13, further comprising a cam roller, wherein said slide elements of said lifting elements each interact with said control cam through said cam roller.

20. The apparatus of claim 13, further comprising a transport element comprising a section, and an arm that projects laterally from said slide element, wherein said fluid pressure actuation element acts between said section and said arm.

21. The apparatus of claim 13, further comprising a transport element comprising an annular section, and an arm that projects laterally from said slide element, wherein said fluid pressure actuation element acts between said annular section and said arm.

22. The apparatus of any claim 13, wherein each lifting element is configured for a maximum stroke of 50 millimeters.

23. The apparatus of any claim 13, wherein each lifting element is configured for a maximum stroke of between 30 millimeters and 40 millimeters.

24. The apparatus of claim 13, wherein said guideway is free of sealing elements.

25. The apparatus of claim 13, wherein said fluid pressure actuation element does not have a guiding function.

26. The apparatus of claim 13, further comprising a container handling machine comprising a transport element, wherein said lifting device is provided on said transport element.

27. The apparatus of claim 13, further comprising a filling machine comprising a transport element, wherein said lifting device is provided on said transport element.

28. The apparatus of claim 13, further comprising a filling machine comprising a rotor that rotates about a machine axis of said filling machine, wherein said lifting device is provided on said rotor.

29. The apparatus of claim 13, further comprising a pressure source for a common pressure medium, a container handling machine comprising a transport element, and a common rotary connection between said pressure source and said transport element, wherein said lifting device is provided on said transport element, wherein said lifting elements each comprise a handle, wherein said handle, together with said lifting element, defines a handling position, wherein said apparatus further comprises a pressure-medium-actuated control valve for each handle, wherein said common pressure medium from said pressure source pressurizes actuation elements of all of said lifting elements, and wherein said common pressure medium from said pressure source activates said control valves of said handles, wherein said common pressure medium is fed via said common rotary connection from said pressure source, and wherein said handle is selected from the group consisting of a handling element and a handling head.

30. The apparatus of claim 13, further comprising a filling machine comprising a transport element, a pressure source for a common pressure medium, and a common rotary connection between said pressure source and said transport element, wherein said lifting device is provided on said transport element, wherein said lifting elements each comprise a handle, wherein said handle, together with said lifting element, defines a filling position, wherein said apparatus further comprises a pressure-medium-actuated control valve for each handle, wherein said common pressure medium from said pressure source pressurizes actuation elements of all of said lifting elements, and wherein said common pressure medium from said pressure source activates said control valves of said handles, wherein said common pressure medium is fed via said common rotary connection from said pressure source, and wherein said handle is selected from the group consisting of a handling element and a handling head.

31. The apparatus of claim 13, further comprising a filling machine, wherein said lifting elements are disposed on a transport element of said filling machine, wherein said lifting elements each comprise a handle, wherein said handle, together with said lifting element, defines a filling position, wherein each lifting element further comprises a structure that is configured to selectively extend into a container, wherein said structure is height adjustable in a direction extending between said first lifting position and said second lifting position, wherein said structure is selected from the group consisting of a filling tube that extends into a container during filling thereof and a probe that determines a filling level in said container.

32. The apparatus of claim 13, wherein said fluid pressure actuation element is manufactured from a material selected from the group consisting of an elastic material and a plastic material.
